(19) United States
(12) Patent Application Publication
(10) Pub. No.: US 2005/0192785 A1
(43) Pub. Date: Sep. 1, 2005

(54) Computer simulator for continuously variable transmissions

(76) Inventors: Alan D. Lewis, Coralville, IA (US); Toshihiro Saito, Wako-shi (JP)

Correspondence Address: ARENT FOX PLLC, 1050 CONNECTICUT AVENUE, N.W., SUITE 400, WASHINGTON, DC, 20036, US

(21) Appl. No.: 11/063,733

(22) Filed: Feb. 24, 2005

Related U.S. Application Data
(60) Provisional application No. 60/548,101, filed on Feb. 27, 2004.

(51) Int. Cl. G06G 7/48

(52) U.S. Cl. 703/8

(57) ABSTRACT

Improvements are made to a multi-body simulation (MBS) for computing belt dynamics in metal pushing V-Belts for CVTs. All of the improvements combine to more accurately model the forces in the CVT mechanism, and also provide insight into the mechanism performance. One improvement more accurately captures effects of ring bending, using ring and block gap geometry to calculate bending forces and torques. A second improvement is implementation of a thrust controller to adjust pulley thrust to control CVT input/output speed ratio. Pulley thrust is adjusted by means of a feedback loop until a desired speed ratio is obtained. Finally, pulley conical (tilt) deflection is modeled using a stiffness representation that is a function of the block radius on the pulley face.

### BACKGROUND OF THE INVENTION

1. Field of the Invention

The present invention relates to a computer simulator for continuously variable transmissions (CVTs), more particular to a computer simulator for analyzing dynamics in metal pushing V-belt systems for vehicle CVTs to predict or analyze the durability of the V-belt systems.

2. Description of the Related Art

The design process for developing a CVT V-belt system requires a number of physical prototypes of the CVT V-belt system, requiring significant expenditures of time and costs. For that reason, simulation is used to test potential designs and reduce the number of physical prototypes needed. The simulation allows modeling of design innovations, and identifies promising directions for design improvement.

As a tool for mechanism analysis, multi-body computer simulation has been well known. For example, the multi-body computer simulation of a CVT V-belt is described in U.S. Pat. No. 6,568,280, wherein the block is modeled as rigid body and the ring is modeled as state equation representations that interact with the rigid block. However, this existing simulation uses an iterative approach to arrive at a quasi-static representation of the ring tension, rather than performing a transient simulation to arrive at a true dynamic balance of the block, ring, and pulley forces.

Also, this existing simulation does not utilize the actual block and ring geometry in calculating ring bending forces and torques, and does not include a technique for maintaining a desired speed ratio of the belt, thereby rendering it difficult to predict or analyze the durability of the V-belt system.

### SUMMARY OF THE INVENTION

The object of the present invention is solve the drawbacks of the prior art and to provide a computer simulator for CVTs that improves upon the existing computer simulator by performing a transient simulation to arrive at a true dynamic balance of the block, ring, and pulley forces, while utilizing the actual block and ring geometry in calculating ring bending forces, and including a technique for maintaining a desired speed ratio of the V-belt system, thereby allowing the user to accurately predict or analyze the durability of the V-belt system.

In order to achieve the objects, the present invention provides a computer simulator for a continuously variable transmission having a metal-pushing belt comprising at least a plurality of blocks and a ring mounted on the blocks and wound around pulleys, comprising: a multi-body simulation unit that performs multi-body simulation using a multi-body simulation model, comprising a block model, a ring model and a pulley model, which model components of a belt system comprising the blocks, the ring and the pulleys and which describes a bending force acting on the ring based on a positional relationship of the blocks relative to the ring; a thrust controller that controls pulley thrust of the pulley model such that a speed ratio to be transmitted converges to a desired speed ratio in the multi-body simulation; a non-linear FE analysis unit that inputs the pulley thrust when the controller is in operation and analyzes non-linear element of the belt system using a finite element model that models the non-linear element of the belt system through a finite element method, to predict stresses acting on the components of the belt system; and a durability analysis unit that inputs the predicted stresses and predicts durability of the components of the belt system.

### BRIEF DESCRIPTION OF THE DRAWINGS

The above and other objects and advantages of the present invention will be more apparent from the following description and drawings, in which:

FIG. 1 is an overall cross-sectional view of a V-belt system for CVT (continuously variable transmissions) to which a computer simulator for CVTs according to the embodiment of the present invention is applied;

FIG. 2 is a photograph showing a V-belt system of the CVT illustrated in FIG. 1;

FIG. 3 is a schematic view showing a CVT block, its features, and its dimensions illustrated in FIG. 2;

FIG. 4 is a block diagram showing a detailed configuration of the computer simulator according to the embodiment and showing, as a whole, a typical design process for developing the CVT V-belt system;

FIG. 5 is a view showing a multi-body simulation model of the V-belt system used in a system multi-body simulation unit of the computer simulator illustrated in FIG. 4;

FIG. 6 is a block diagram showing a detailed configuration of the system multi-body simulation unit, as well as the relationships of components (models) constituting the multi-body simulation model used in the system multi-body simulation unit and illustrated in FIG. 5;

FIG. 7 is a schematic side view of the CVT block, illustrated in FIGS. 2 and 3, showing the relationship between two blocks, for purposes of calculating ring bending;

FIG. 8 is a graph showing a “dead-band” envelope of ring bending displacements, which is a function of the block and ring geometry;

FIG. 9 is a set of views schematically showing the various “breakpoint” block and ring configurations that define the ring bending dead-band envelope illustrated in FIG. 8;

FIG. 10 is a block diagram showing a thrust controller, illustrated in FIG. 6, used to control the CVT speed ratio by means of adjustments to the pulley thrust;

FIG. 11 is a view showing a conical stiffness of the CVT pulley illustrated in FIG. 1;

FIG. 12 is a block diagram showing the implementation of the pulley conical stiffness illustrated in FIG. 11; and

FIG. 13 to FIG. 16 are a set of graphs or plots showing “resultant vectors” of various forces on the CVT pulley face models and block models illustrated in FIG. 6.

### DESCRIPTION OF THE PREFERRED EMBODIMENT

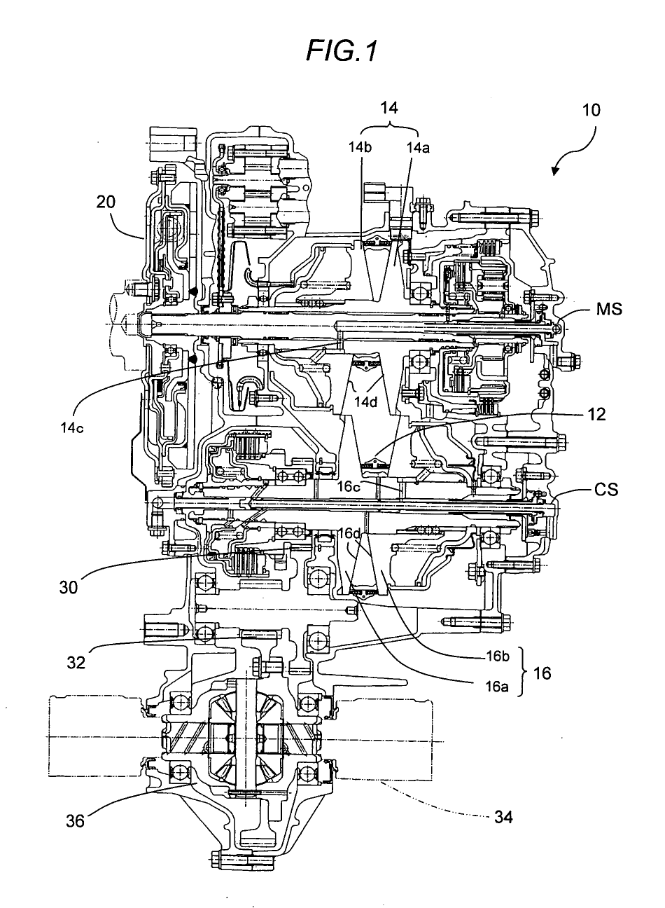

FIG. 1 is an overall cross-sectional a V-belt system of a continuously variable transmission (hereinafter simply referred to as the “CVT”) to which a computer simulator for CVTs according to the embodiment is applied.

In the figure, reference numeral 10 indicates a CVT having a metal-pushing V-belt 12. The V-belt 12 is wound around pulleys 14, 16 that are fixed on a main shaft (transmission input shaft) MS connected to a crankshaft (not shown) of the internal combustion engine through a flywheel 20 having a dumper mechanism, and on a countershaft (transmission output shaft) CS provided in parallel with the main shaft MS to be mounted on a vehicle (not shown)

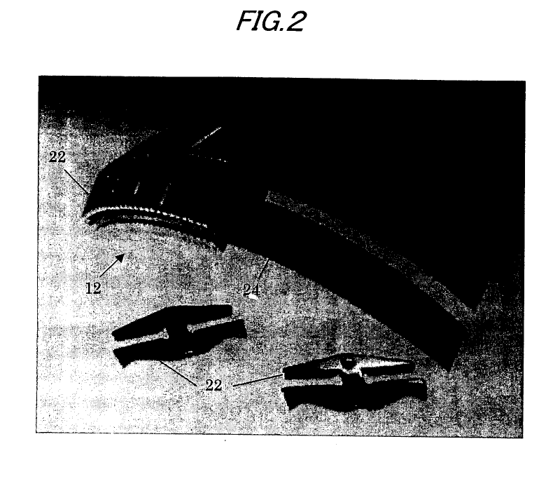

FIG. 2 is a photograph showing the V-belt 12 in detail. As shown in FIG. 2, the V-belt 12 includes a plurality of, i.e., 428 V-shaped blocks 22 (hereinafter collectively referred to the “block”) and a ring 24 made of a plurality of, i.e., two rows of 12 bands. The V-belt 12 are each made of a thin metal plate such as iron or steel and the bands of the ring 12 are each made of a thin metal plate such as maraging steel.

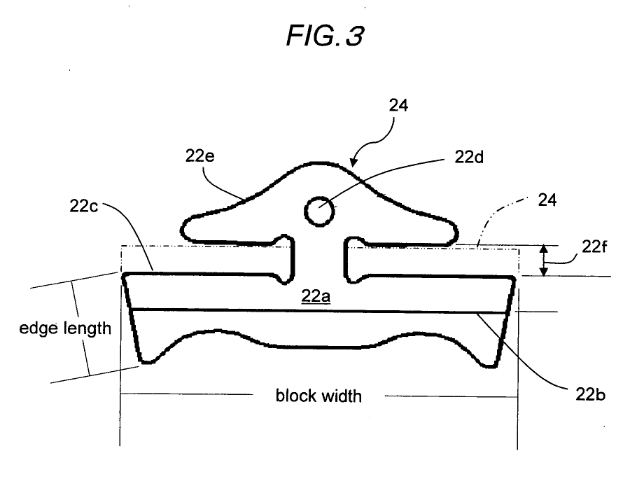

FIG. 3 is a schematic view showing the block 22 in the V-belt 12.

As shown in FIG. 3, the block 22 is a trapezoidal shape, and has friction surfaces 22a on its front and rear surfaces, a rocking edge 22b formed at the front face on the wedged lower body, saddles 22c on each side of its shoulders and a nose 22d formed at the front surface of a triangular-shaped head 22e and a dimple (not shown) at the rear surface of the head 22e to receive the nose 22d. The two rows of the bands of the rings 24 are mounted on the saddles 22c in each gap 22f formed between the shoulders and the head 22e, as shown by phantom lines.

In the CVT 10 shown in FIG. 1, the pulleys 14 is made of a pulley half 14a fixed on the main shaft MS and a pulley half 14b that is movable along the main shaft MS when applied hydraulic pressure through a hydraulic oil passage 14c. Similarly, the pulleys 16 is made of a pulley half 16a fixed on the counter shaft CS and a pulley half 16b that are movable along the counter shaft MS when applied hydraulic pressure through a hydraulic oil passage 16c.

The countershaft CS is connected to a final drive gear 30 and the final drive gear 30 is connected to a final driven gear 32. The final driven gear 32 is connected to a driveshaft 34 through a differential 36. The driveshaft 34 is connected to driven wheels (not shown) of the vehicle. Thus, the driving torque is shifted and transmitted by the V-belt 12 from the drive pulley 14 to the driven pulley 16, whereby the power is transmitted from the engine to the driven wheels. In addition, the mechanism of the CVT 10 shifts the speed ratio by moving a pair of opposing movable pulleys 14, 16 in the axial direction of the main shaft MS and the counter shaft CS, such that the radius at which the V-belt 12 is contacting faces 14d, 16d of the pulleys 14, 16, changes.

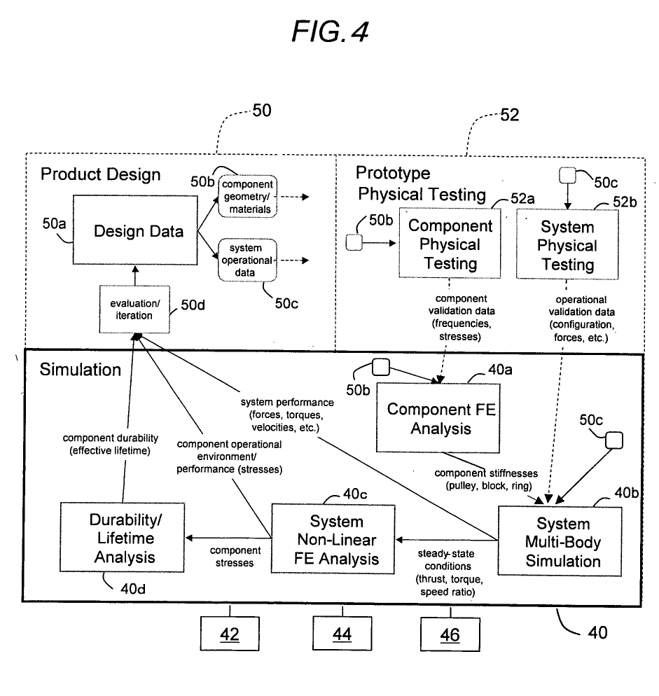

FIG. 4 is a block diagram showing a detailed configuration of the computer simulator in a functional manner and showing, as a whole, a typical design process for developing the CVT V-belt system.

In the figure, reference numeral 40 indicates the computer simulator. The computer simulator 40 comprises a microcomputer having a CPU (central processing unit), a ROM (read-only memory), a RAM (random access memory), an input circuit, and an output circuit (neither shown), etc, and an inputting device 42 including a key board, a mouse, etc., a monitor (display) 44, and an outputting device 46 including a printer.

The computer simulator 40 performs a multi-body simulation (that is a technique of mechanism analysis), and computes or analyzes belt dynamics of the V-belt 12 to predict or analyze the durability of the V-belt 12, as will be explained below.

As illustrated in FIG. 4, the computer simulator 40 includes a component FE analysis unit 40a, a system multi-body simulation unit 40b, a system non-linear FE analysis unit 40c and a durability/lifetime analysis unit 40d. Further, the computer simulator 40 is connected to a product design unit 50 and a prototype physical testing unit 52. The product design unit 50 and prototype physical testing unit 52 are constituted as data bases or hard discs that are independent of or separate from the computer simulator 40, but are communicated with the computer simulator 40 via internet or some similar communication lines.

The product design unit 50 is well known. Based on design data stored in a design data unit 52a, it determines and stores geometries and materials of the components (i.e., the pulley 14, 16, block 22 and ring 24) in a memory unit 50b and operational data of the system (i.e., the V-belt system constituted by the components) in a memory unit 50c. The product design unit 50 has an evaluation/iteration unit 50d that stores evaluation data of the components obtained through iteration of simulation.

The prototype physical testing unit 52 is also well known and includes a component physical testing unit 52a that inputs the data stored in the memory unit 50b and outputs operational validation data, i.e., frequencies, stresses, of the components obtained through physical testing made on the components, and a system physical testing unit 52b that inputs the data stored in the memory unit 50c and outputs operational validation data, e.g., configuration, forces, etc., of the system obtained through physical testing made on the system.

The component FE analysis unit 40a inputs the data stored in the memory unit 50b and the outputs from the component physical testing unit 52a, and analyzes and outputs stiffness of the components obtained by analysis using finite element (FE) models in the finite element method. Specifically, the components of the V-belt system are physically tested in the unit 52a to determine endurance limits of the components and effective lifetime or durability. The data is then used in the unit 40a to correlate the finite element (FE) models of the components. These correlated models are modified slightly to represent the components, such that endurance limits and effective lifetimes would be predicted for the components as explained below.

The system multi-body simulation unit (hereinafter referred to as the “system MBS unit) 40b inputs the data stored in the memory unit 50c and the outputs from the system physical testing unit 52b and component FE analysis unit 40a, performs a multi-body simulation (hereinafter referred to as “MBS”) using a multi-body simulation model (hereinafter referred to as the “MBS model”; explained below) on the V-belt system, analyzes the result of simulation and outputs as the performance of the system (e.g., forces, torques, velocities, etc.) to the evaluation/iteration unit 50d of the product design unit 50. The system MBS unit 40b also outputs the characteristics of a steady-state condition (e.g., pulley thrust, torque, speed ratio) achieved by a controller (explained later).

Thus, the system MBS unit 40a predicts forces, torques, accelerations, velocities, etc. of the system and its components. These values can be compared to values measured in test of the prototype physical testing unit 52, for validation purposes. In particular, pulley thrust forces under steady-state conditions are an indicator of the “goodness” of the MBS model.

The system non-linear FE analysis unit 40c inputs the output from the system MBS unit 40b, analyzes based on a finite element model that models the non-linear element of the system, and outputs the operational environment and performance of the components (e.g., stresses acting thereon) to the evaluation/iteration unit 50d of the product design unit 50 and the stresses acting on the components to the durability/lifetime analysis unit 40d.

Thus, validated steady-state conditions of the MBS model in the MBS are used as the inputs to the non-linear FE model of the belt system in the system non-linear FE analysis unit 40c. The MBS data provides the initial conditions for the non-linear FE model. The non-linear FE model is used to predict stresses over time (for example, over one rotation of the belt).

It should be noted that, although forces, torques, etc. can be calculated by the system non-linear FE analysis unit 40c, the MBS model generally requires much less computation time. Because of this, the MBS is used to calculate steady-state characteristics of the V-belt system for use by the non-linear FE analysis. This eliminates the need for “settling” time in the non-linear FE analysis unit 40c, thus greatly reducing the overall computation time.

The durability/lifetime unit 40d inputs the output from the system non-linear FE analysis and based on the inputs, analyzes or predicts the durability or lifetime of the components, and outputs the same to the evaluation/iteration unit 50d of the product design unit 50.

Thus, in the computer simulator 40 for CVTs according to the embodiment of the present invention, once stresses are available from the non-linear FE analysis, a prediction of the effective lifetime of the V-belt system can be made. Once the entire simulation process has been validated, new designs can be simulated with confidence. New designs can be simulated to determine whether they will meet operational requirements (e.g. torque transmitting), as well as to determine whether they will meet effective lifetime requirements. The computer simulator 40 can require less time and expense than the physical prototyping and testing process, although some physical testing is still required.

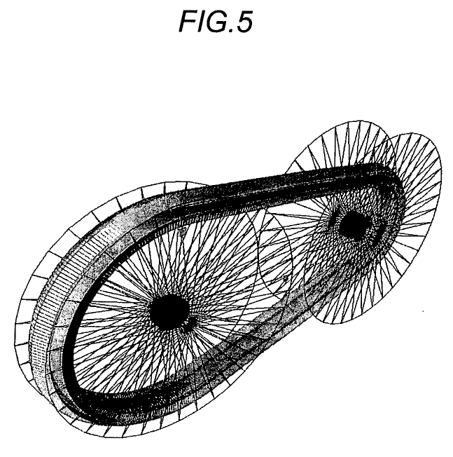

FIG. 5 is a view showing the MBS model of the V-belt system used in the system MBS unit 40b of the computer simulator 40 illustrated in FIG. 4.

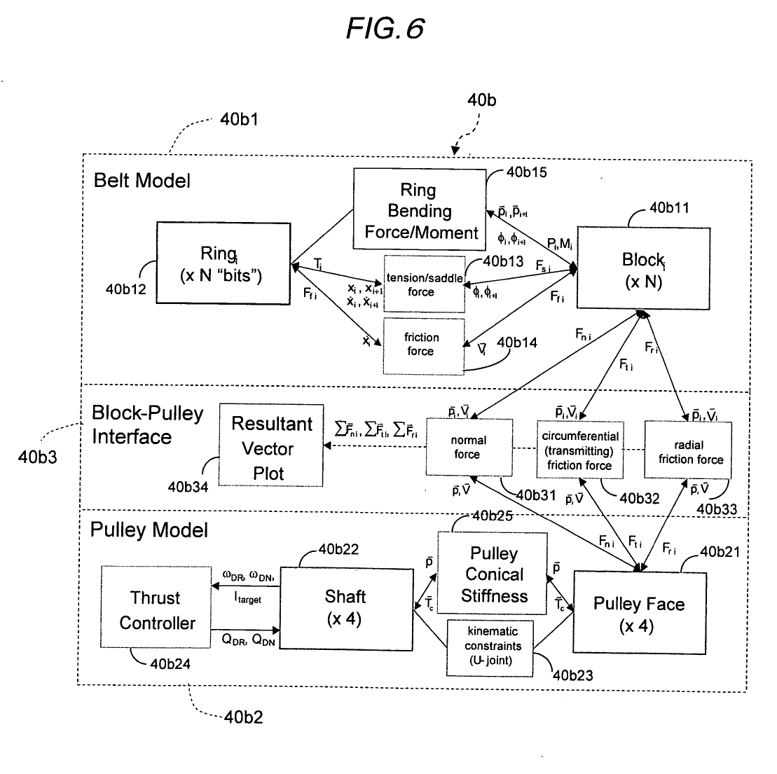

FIG. 6 is a block diagram showing a detailed configuration of the system MBS unit 40b, as well as the relationships of components (models) constituting the MBS model used in the unit 40b and illustrated in FIG. 5. Here, FIG. 6 shows all of the elements of the simulation performed in the computer simulator 40, as well as the flow of data from one element of the model to another.

As illustrated, the system MBS unit 40b includes a belt model 40b1, a pulley model 40b2 and a block-pulley interface 40b3.

In the belt model 40b1, a block unit 40b11 indicates physical components of the block 22, a ring unit 40b12 indicates those of the ring 24. Similarly, in the pulley model 40b2, a pulley face model 40b21 indicates physical components of the faces 14d, 16d of the pulleys 14, 16, a shaft model 40b22 indicates those of shafts (the main shaft MS and counter shaft CS).

Further, in the belt model 40b1, pulley model 40b2 and block-pulley interface 40b3, calculation units 40b13, 40b14, 40b23, 40b31, 40b32, 40b33 calculates forces and constraints in the same manner as the prior art.

The characteristic features of the configuration illustrated in FIG. 6 includes a ring bending force/moment unit 40b15 added in the belt model 40b1, a thrust controller (the controller referred to above) 40b24 added in the pulley model 40b2 and a pulley conical stiffness calculation unit 40b25, and a resultant vector plot (calculation) unit (visualization unit) 40b34 added in the bock-pulley interface 40b3.

Before entering the explanation of FIG. 6, the object of the present invention is again discussed.

As stated above, since the design process for developing a CVT V-belt system requires a number of physical prototypes of the CVT V-belt system, simulation is used to test potential designs and reduce the number of physical prototypes needed. Among various types of simulation, as a tool of mechanism analysis, the MBS has been known as described in U.S. Pat. No. 6,568,280, wherein the block is modeled as rigid body and the ring is modeled as state equation representations that interact with the rigid block.

However, the prior art simulation uses an iterative approach to arrive at a quasi-static representation of the ring tension, rather than performing a transient simulation to arrive at a true dynamic balance of the block, ring, and pulley forces. Also, the prior art simulation does not utilize the actual block and ring geometry in calculating ring bending forces and torques, does not include a technique for maintaining a desired speed ratio of the belt, thereby rendering difficult it to predict or analyze the durability of the V-belt system.

In order to solve the drawbacks of the prior art, the system MBS unit 40b in the computer simulator according to this embodiment is configured in the manner mentioned just above.

Specifically, to create an accurate simulation, it is necessary to accurately calculate the internal loads of the CVT V-belt, and to accurately transmit these loads to the pulley faces. It is also necessary to apply pulley thrust forces that will maintain a desired speed ratio.

To increase the accuracy of CVT V-belt simulation, these necessities are addressed by three improvements to the prior art simulation technique:

First, in the ring bending force/moment calculation unit 40b15 of the belt model 40b1, the geometry of actual block 22 and ring 24 is used to more accurately represent the bending characteristics of the ring in the block. Specifically, in the unit 40b15, the spaces between the ring 24 and the block gap 22f are monitored (i.e., calculated), and bending forces and torques are adjusted based on actual contact between the ring 24 and the block edges. This improves the accuracy of the belt internal forces.

Second, in the pulley model 40b2, the thrust controller 40b24 is introduced to control the CVT (i.e., the V-belt system) speed ratio. The difference or error between a desired and simulated speed ratio is found, and this error signal (and its integral) is used to control the thrust force on one of the CVT pulleys, and the error signal is minimized. This allows a desired speed ratio to be maintained, and the simulated pulley thrust to be examined as a measure of the accuracy of the simulation.

Third, in the pulley model 40b2, a conical stiffness function is implemented by the pulley conical stiffness calculation unit 40b25 to allow limited tilting of the pulley face (model) about the shaft (model) connection. In the CVT 10 illustrated in FIG. 1, this stiffness is greater when the block 24 ride at a small radius on the face 14d or 16d of the pulley 14 or 16, and less when the block 24 rides at a large radius. This stiffness variation with radius is accounted for in the simulation. This improves the accuracy of the transmission of the belt forces to the pulley faces.

The conical tilt of the pulley face has significant effects on the CVT V-belt system response (ring tension, contact force between blocks, etc.). The resultant vector plot (visualization) unit 40b34 is added in the block-pulley interface 40b3 to visualize, through the display 44, the various forces at work on the block and pulley models. This technique gives insights into the balance of forces in the CVT V-belt system.

The combination of these techniques ensures that the internal CVT V-belt forces are accurately calculated, and accurately applied to the pulley faces, and that the pulley thrust accurately resists the belt forces. These techniques also provide insight into the simulation accuracy and the internal workings of the mechanism.

The above will further be explained in detail.

Modeling Background

In FIG. 6, physical components of the model shown by reference numeral 40b11, etc. represent physical degrees of freedom in the model. Each individually identifiable component of the mechanism of the CVT 10, such as the main shaft MS and counter shaft CS and the V-belt block 22, are represented in the MBS model by a “rigid body,” which is able to move through space with three translational and three rotational degrees of freedom (DOF). Being a rigid body, no part of the component may translate or rotate with respect to itself.

In addition to rigid bodies, the CVT V-belt simulation (in the computer simulator 40) includes degrees of freedom for the belt ring 24. The ring 24 is not modeled as six-DOF rigid bodies. Rather, they are assumed to travel primarily with the block 22, but to have one circumferential degree of freedom relative to the block 22. That is, the ring 24 is allowed to slide relative to the surface of the block saddle 22f, in the direction of the belt motion. One ring “bit” i.e., a segment of the ring 24 is associated with each block 22.

The forces and constraints (that are the same as those used in existing-technology) are added in FIG. 6, by reference numerals 40b13, etc. In the MBS model, the relationship between rigid bodies is defined by means of force elements (which tend to initiate or resist motion in a given direction) and kinematic joints (which prevent motion altogether in a given direction). For example, a kinematic joint and a force element connect the shafts (MS, CS) and faces of the pulleys 14, 16.

The kinematic joint is a universal-type joint, which prevents any relative translation (three DOFs) and one relative rotation (axial rotation) between the two rigid bodies at the connection point. This allows two relative rotations (tilt about two orthogonal axes), which are resisted by the conical stiffness force improvement described below.

If a given V-belt block is in contact with the pulley face, both a contact force (normal to the pulley face) and a friction force (tangential to the face) are generated, based on the degree of interference and relative velocity of the contacting surfaces. For convenience in interpreting the simulation results, the friction force is further divided into a transmitting (circumferential) and a radial component. These forces are applied as action-reaction forces to both the block and pulley face models. Similar calculations are performed for each block and pulley face model.

Several forces (calculated in the calculation units 40b31, 40b32 and 40b33) define the relationship between the block models and ring models. Some of these forces are implemented in the prior art simulation (U.S. Pat. No. 6,568,280). These include the tension forces in the ring model, the resulting saddle force on the block model, and the block-ring friction force. The combination of ring tension and the incident angle between two blocks creates a normal (radial) force on the block saddle surface. In addition, because the ring model is allowed to slide relative to the block saddle surface, a friction force is generated in the circumferential direction.

The ring bending force/moment calculation 40b15 generates additional forces on the block model.

The thrust controller (controller) 42b24 generates forces that squeeze the pulley face models together, clamping the V-belt, which in turn generates the pulley-belt friction forces used to drive the mechanism. The conical stiffness force allows some small tilt of the pulley faces due to the pulley material flexibility.

As referred to in the above, the resultant vector plot unit 40b34 generates plots that visualize the component forces acting between the block models and pulley face models.

In FIG. 6, the connections in the diagram are labeled to identify the type of data that is communicated between the various elements of the model. In the figure, the following nomenclature is used:
\overline{p}, \overline{V} position and velocity vectors of a rigid body (includes translations and rotations)
\overline{p}ᵢ, \overline{V}ᵢ position and velocity vectors of a block rigid body (repeated for each block)
φᵢ pitch orientation of a block rigid body (repeated for each block)
xᵢ, \dot{x}ᵢ circumferential position and velocity of a ring “bit” (repeated for each bit)
ω_{DR}, ω_{DN} angular velocities of the drive and driven pulleys
I_{target} target speed ratio
\overline{T}_{c} conical torque vector
Q_{DR}, Q_{DN} thrust forces on the drive and driven pulleys
Fₙᵢ, Fₜᵢ, Fᵣᵢ normal, circumferential (tangential), and radial components of block-pulley contact force (repeated for each block)
Pᵢ, Mᵢ ring beam bending load and moment (repeated for each block)
Fₛᵢ saddle normal force due to ring tension (repeated for each block)
F_{fi} saddle friction force due to ring tension (repeated for each block and bit)
Tᵢ ring tension of a ring “bit” (repeated for each bit)
Σ\overline{F}ₙᵢ, Σ\overline{F}ₜᵢ, Σ\overline{F}ᵣᵢ summations of normal, circumferential (tangential), and radial components of block-pulley contact force, in vector form (summed over all blocks)

Other characteristic features in FIG. 6 are described in detail in the following. These improvements affect each stage of the CVT model.

Ring Beam Bending

A number of forces exist between the CVT belt ring 24 and block 22. Among these is the possibility that beam bending forces may be created by misalignment of adjacent blocks. If the misalignment is severe enough, the ring will bind on the edges of the gap 22f (FIG. 3) in the block 22.

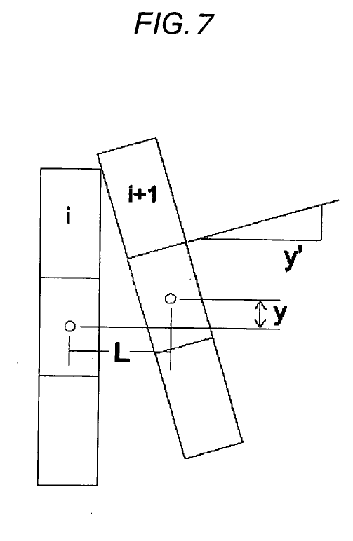

The misalignment between two blocks is shown conceptually in FIG. 7. Two blocks (“i” and “i+1”) are shown as rectangles at the both ends, with one mid rectangle representing the gap 22f in the block 22 through which the ring 24 is placed. One block (block “i”) is chosen as the reference block, and a reference point (dot in the figure) is chosen on each block. The location and orientation of the reference point on the secondary block (block “i+1”) is calculated with respect to the reference point on the reference block.

The location of the second block is separated into a length (“L”) and a radial displacement (“y”), and the relative orientation angle is calculated as a slope (“y′”). Given these values, and knowing the physical characteristics of the ring (cross-sectional dimensions, Young's modulus), a shear force and moment can be back-calculated for a uniform beam with the given length, deflection, and slope, using classical beam bending theory.

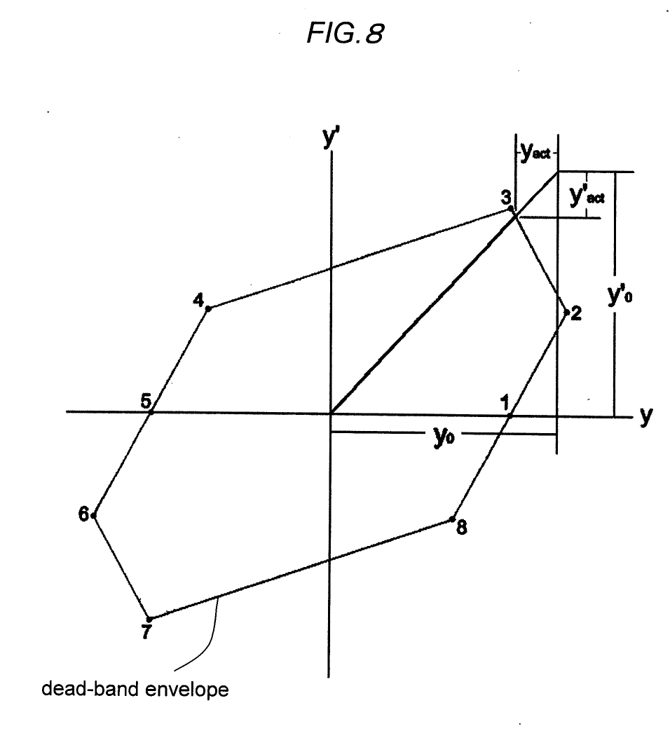

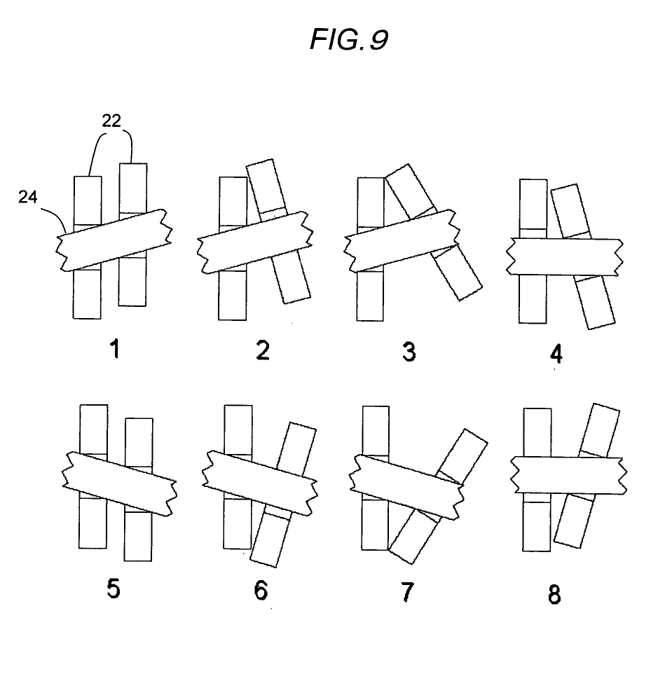

However, some displacement and slope should be allowed before any bending loads are transmitted from the ring to the block, because the V-belt 12 is intentionally designed with some gap 22f between the ring 24 and block 22. An envelope can be defined as a function of y and y′, wherein no bending loads are transmitted to the block (shown as “dead-band envelope” in FIG. 8). The boundaries of this envelope are a function of the geometry of the ring 24 and block 22, and the distance (“L”) between the blocks 22. The envelope will have a number of “breakpoints” or vertices, each of which corresponds to a specific position/orientation of one block with respect to another. The breakpoints in FIG. 8 are numbered, and the specific configuration represented by each breakpoint is shown conceptually in FIG. 9, where a portion of the ring 24 is shown as a broken rectangle.

In FIG. 9, numeral “1”, the ring and the block gap define an angle “φ_{ref}”, which is calculated as follows:

$$sin {ϕ}_{ref} = \frac{- {t}_{r} {t}_{b} + {h}_{g} \sqrt{{h}_{g}^{2} + {t}_{b}^{2} - {t}_{r}^{2}}}{{h}_{g}^{2} + {t}_{b}^{2}}$$

where “tr” is the total thickness of the ring, “tb” is the thickness of the block, and “hg” is the gap height.

In this same sub-figure identified by the number, a distance “y_{ref}” can be defined, which is the vertical distance between the center-points of the two blocks:
y_{ref}=L tan φ_{ref}

Another useful displacement value, “y₂”, is used in the odd-numbered sub-figures:

$${y}_{2} = \frac{{h}_{g} - {t}_{r}}{2 cos {ϕ}_{ref}}$$

Using these values, the relative displacements and orientations of the blocks at each of the breakpoints is as follows:

| Breakpoint # | Δy | Δφ |
|---|---|---|
| 1 | +y_{ref} | 0 |
| 2 | +y_{ref} +y₂ | +φ_{ref} |
| 3 | +y_{ref} | +2φ_{ref} |
| 4 | −y_{ref} +y₂ | +φ_{ref} |
| 5 | −y_{ref} | 0 |
| 6 | −y_{ref} −y₂ | −φ_{ref} |
| 7 | −y_{ref} | −2φ_{ref} |
| 8 | +y_{ref} −y₂ | −φ_{ref} |

Once the breakpoints are calculated for the specific block geometry, and the displacement and slope are found for a block pair, the unadjusted (y₀, y′₀) point is plotted with respect to the envelope, and a vector is drawn from the origin to that point. The intersection point is found between the (y₀, y′₀) vector and the envelope, and the portion of the vector lying inside the envelope is discarded. The remaining vector (y_{act}, y′_{act}) is used to calculate the beam bending loads between the ring and block.

Once the adjusted deflection and slope are calculated, classic beam bending equations are used to determine load and moment values. It is assumed that equal and opposite loads occur at each end, and that a counter-acting moment is also present. Given this assumption, the slope and deflection can be calculated from the following equations:

$${y}_{act} = \frac{{M}_{0}}{2 EI} {L}^{2} + \frac{{P}_{0}}{6 EI} {L}^{3}$$

$${y}_{act}^{′} = \frac{{M}_{0}}{EI} L + \frac{{P}_{0}}{2 EI} {L}^{2}$$

where “P₀” is the load and “M₀” is the moment at the “i” end, “E” is the Young's modulus of the ring material, and “I” is the total area bending moment of the rings. From these equations, P₀ and M₀ can be back-calculated, along with the load and moment at the “i+1” end (“P_{L}” and “M₀”):

$${P}_{0} = EI ( - 12 \frac{{y}_{L}}{{L}_{bit}^{3}} + 6 \frac{{y}_{L}^{′}}{{L}_{bit}^{2}} )$$

$${M}_{0} = EI ( 6 \frac{{y}_{L}}{{L}_{bit}^{2}} - 2 \frac{{y}_{L}^{′}}{{L}_{bit}} )$$

$${P}_{L} = - {P}_{0}$$

$${M}_{L} = {M}_{0} + {P}_{0} {L}_{bit} = EI ( - 6 \frac{{y}_{L}}{{L}_{bit}^{2}} + 4 \frac{{y}_{L}^{′}}{{L}_{bit}} )$$

These calculated loads and moments are added to any existing normal force and moment on the block. These forces are in turn transmitted to the rest of the mechanism (i.e. pulley faces, shafts).

Thrust Force Controller

In the metal-pushing V-belt CVT, thrust forces are applied to the input and output pulleys 14, 16 to generate frictional forces between the pulley faces and the block edges. These thrust forces are balanced by an on-board computer to maintain a desired speed ratio (gear ratio), and to generate a desired level of output torque.

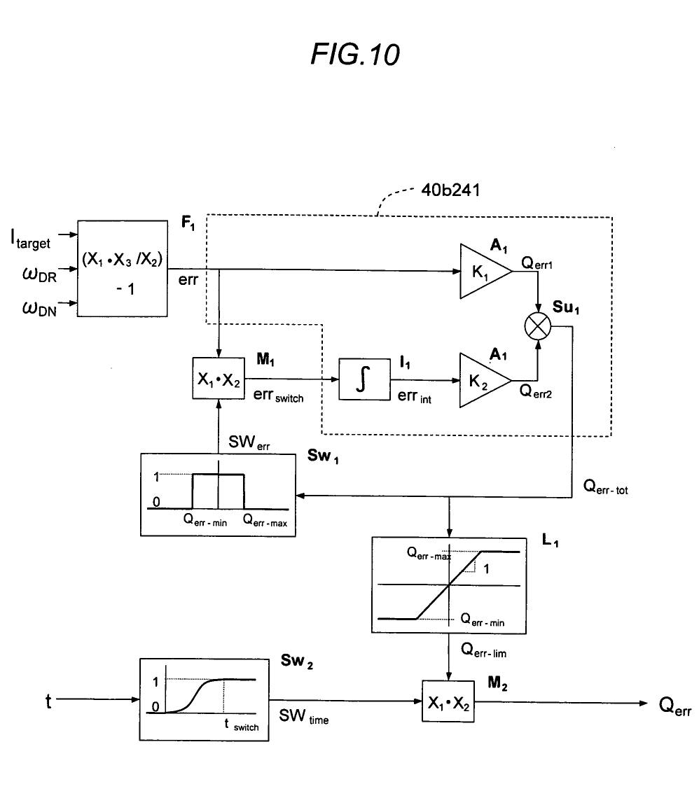

In the simulation, a simplified controller (thrust controller 40b24) is used to achieve the desired speed ratio (whose operation is illustrated in FIG. 10). The simulation begins with a given initial thrust values applied to the drive and driven pulleys (more precisely the pulley face models). The desired speed ratio (I_{target}) is input to the simulation, and sensors are created to monitor the actual angular velocities of the drive and driven pulleys (ω_{DR} and ω_{DN}). A non-dimensional speed ratio error is calculated by means of an algebraic function (block F1):

$$err = {I}_{target} \frac{{ω}_{DN}}{{ω}_{DR}} - 1$$

The main control block (the dashed box in FIG. 10) 40b241 is a traditional proportional-integral (PI) controller. The error signal (err) is multiplied by a gain (K₁ in amplifier A₁) to create a control thrust force (Qₑᵣᵣ₁). The error signal is also integrated (by integrator I₁), and the integral is multiplied by a gain (K₂ in amplifier A₂) to create a second controls thrust force (Qₑᵣᵣ₂) These forces are summed (Su₁) to create a total controller thrust force (Qₑᵣᵣ₋ₜₒₜ).

Several features are added to the traditional PI controller to help insure convergence of the simulation to the desired speed ratio. Two bounds (Qₑᵣᵣ₋ₘᵢₙ and Qₑᵣᵣ₋ₘₐₓ) are defined to prevent the controller thrust from over- or under-loading the controlled pulley. Such under- or over-loading of the pulley can cause the controller to diverge, or may cause the mechanism to physically disassemble.

The total controller thrust (Qₑᵣᵣ₋ₜₒₜ) is fed into a limiting function (L₁), which limits the controller thrust to the range
Qₑᵣᵣ₋ₘᵢₙ≦Qₑᵣᵣ₋ₗᵢₘ≦Qₑᵣᵣ₋ₘₐₓ

The total controller thrust is also fed into a switching function (Sw₁), which is set to zero outside the thrust limit range. The speed ratio error is multiplied by this switch value (M₁) before being fed to the integrator (I₁), to prevent build-up of the error integral function when the controller thrust is being limited.

In addition to the control thrust limiting, a time switch (Sw₂) is implemented to prevent over-response of the controller thrust to transient changes in the model at the beginning of the simulation. A ramp time (t_{switch}) is defined during which the controller thrust increases from zero to the desired value (Qₑᵣᵣ₋ₗᵢₘ). The limited controller thrust is multiplied by this switch value (M₂) to arrive at the final controller thrust (Qₑᵣᵣ).

All of the parameters of the controller (K₁, K₂, Qₑᵣᵣ₋ₘᵢₙ, Qₑᵣᵣ₋ₘₐₓ, t_{switch}) are user-definable.

Once the controller thrust is calculated, it is added to the given initial thrust value of one pulley (i.e., pulley face model). The thrust controller 40b24 can be applied to either the drive or driven pulley (i.e., pulley face model), with only minor changes of sign on various controller variables.

If actual thrust forces are known from physical tests at the prototype physical testing unit 52, the controller thrust can be used as a measure of the accuracy of the simulation in the computer simulator 40. A small controller thrust implies good correlation between test and simulation.

It should be noted that this thrust controller 40b24 may share some features with the real on-board computer controller (not shown), but it is not meant to simulate the real controller. The purpose of the simulation controller (thrust controller 40b24) is only to maintain a desired speed ratio in the simulation, and to determine the controller thrust that must be applied to achieve the desired speed ratio.

Pulley Conical Stiffness

In the simulation, each part of the mechanism, with the exception of the ring 24, is represented as a rigid body. Although the pulleys 14, 16 are quite stiff, they are not truly rigid. In fact, the flexibility of the pulleys 14, 16 helps to distribute the loads from the V-belt 12 around the face of the pulley. If the pulley is treated as rigid, unrealistic force concentrations appear on the pulley face.

The pulley faces could be treated as truly flexible bodies, using finite element modeling (FEM) methods, but this level of detail is not desirable in the simulation, because it would result in excessive computation times or volume. On the other hand, the main influences of the pulley flexibility can be simulated without resorting to FEM modeling of the pulleys.

In view of the above, a universal joint constraint is inserted between the pulley shaft and pulley face models. This joint prevents relative translational motion at the connection point (much like a spherical or ball joint), and permits transmission of torque through the shaft model to the pulley face model.

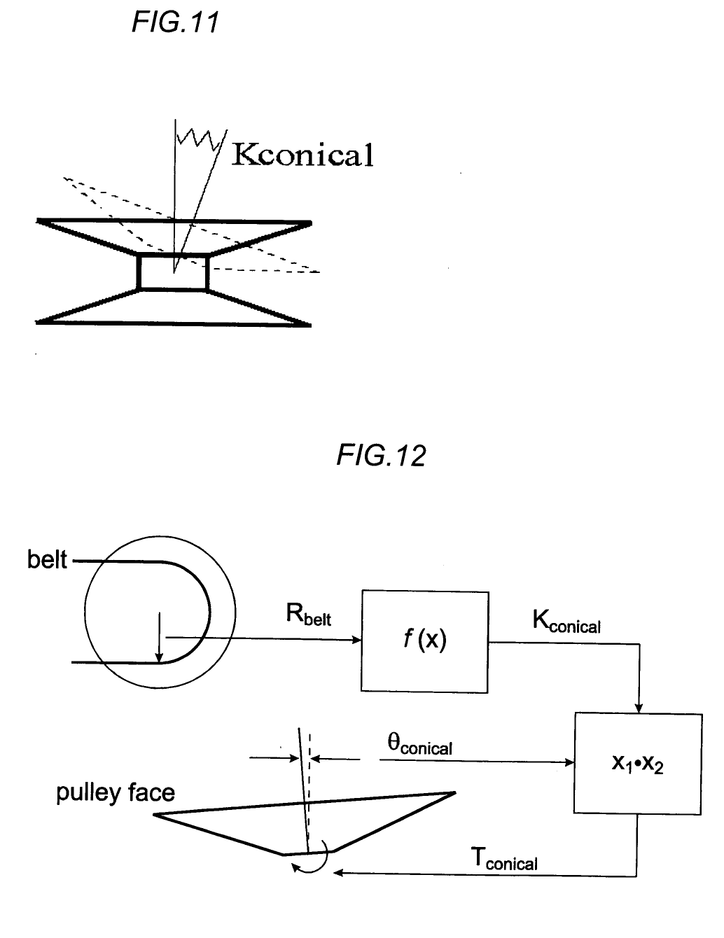

The universal joint allows rotation in the two orthogonal directions in the pulley face, as suggested by FIG. 11, and these two degrees of freedom allow the pulley axis to deviate in any direction from alignment with the shaft. A “conical” stiffness is inserted between the pulley face model and its supporting shaft model, which will allow tilting of the pulley face about any axis perpendicular to the rotation axis of the pulley (K_{conical} in FIG. 11). In this way, the pulley face is allowed to tilt in response to the asymmetric load on the pulley face, but the pulley face and shaft are treated as rigid bodies. This modeling technique results in a computationally efficient, yet accurate simulation.

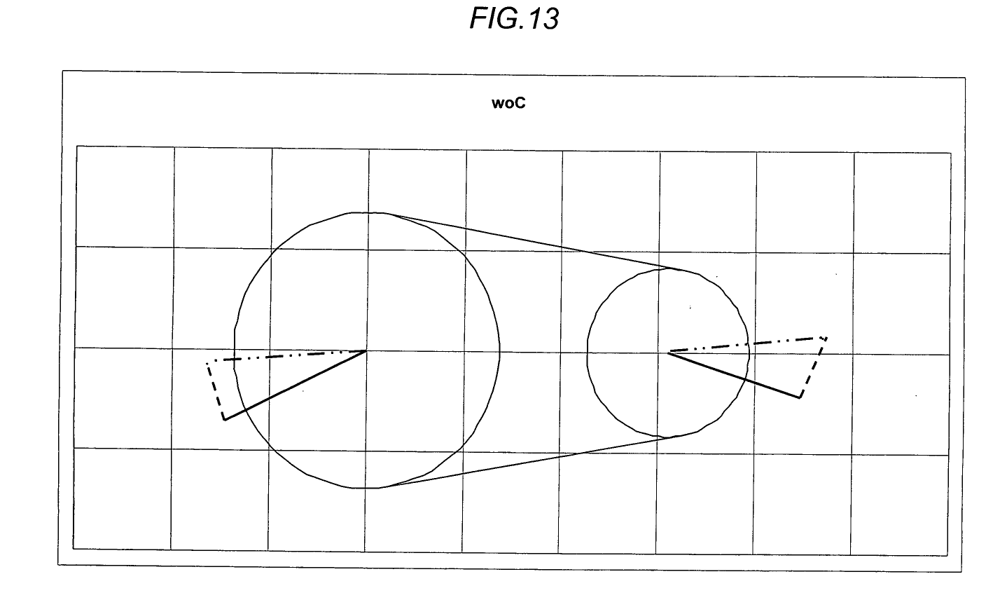

FIG. 12 is a block diagram showing the implementation of the pulley conical stiffness illustrated in FIG. 9.

In the simulation, a series of sensors and functions is used to calculate the resisting conical torque between the shaft and the pulley face (as shown in the block diagram of FIG. 12). In fact, the sensors are not actual detectors, but values obtained through calculation.

The conical stiffness of the pulley is not a constant value, but rather varies depending upon the radius at which the V-belt is contacting the pulley face (R_{belt}). Much as the stiffness of a cantilever beam increases as the force application point moves toward the mounting point, the conical stiffness of the CVT pulley will increase as the V-belt radius decreases. However, because the pulley is a complicated manufactured part, this stiffness relationship to radius is not simple.

In the simulation performed by the computer simulator 40, the radius of the V-belt on the pulley is sensed, based on the positions of the blocks at every time-step during the simulation. The conical stiffness of the pulley (K_{conical}) is calculated from this radius, based on a user-defined non-linear curve (f(x)). The stiffness is multiplied by the sensed conical angle between the shaft and pulley face (θ_{conical}), and the result is used in a “bushing” element (like a rubber bush) that applies a moment to resist tilting of the pulley face (T_{conical}). The process is repeated for both the drive and driven pulleys, and for both the stationary and moveable pulley faces.

The effect of the pulley conical stiffness is made apparent on the display 44 by the resultant vector plot unit 40b34. On each pulley, “resultant vectors” are calculated by the unit 40b34. Each block that contacts a pulley applies a force normal to the pulley face, as well as a friction force that contains radial and circumferential components. Taking the normal force as an example, a resultant vector can be calculated that is the sum of all the normal forces of all the blocks in contact with the pulley face.

Likewise, resultant vectors can be calculated for the radial and circumferential friction forces by the unit 40b34. The sum of these resultant vectors matches the separation force measured between the two pulley shafts. Any moment produced by the drive and driven resultant vectors should match the torque differential between the drive and driven pulleys.

FIG. 13 to FIG. 16 are a set of graphs or plots showing “resultant vectors” of various forces on the CVT pulley face models and block models illustrated in FIG. 6.

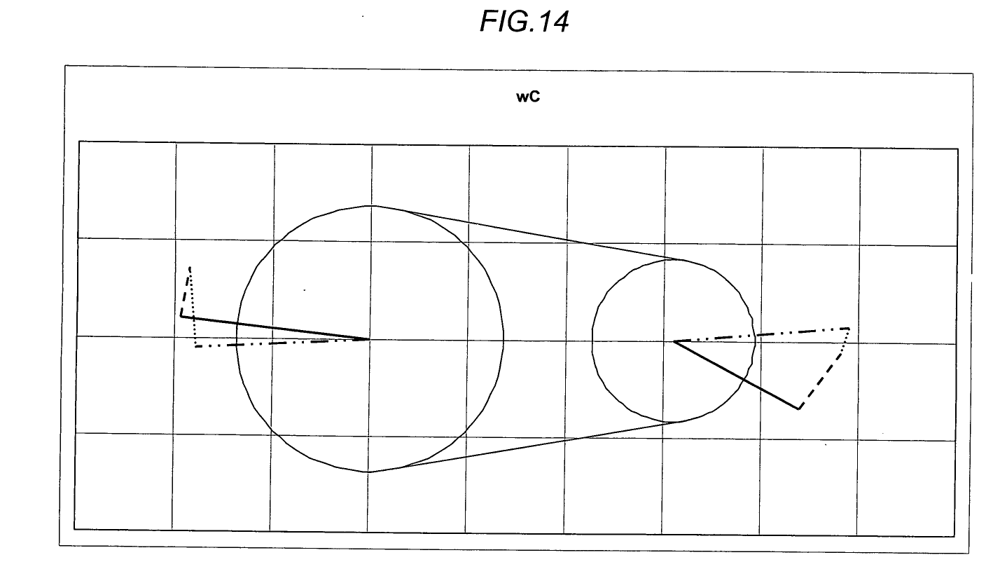

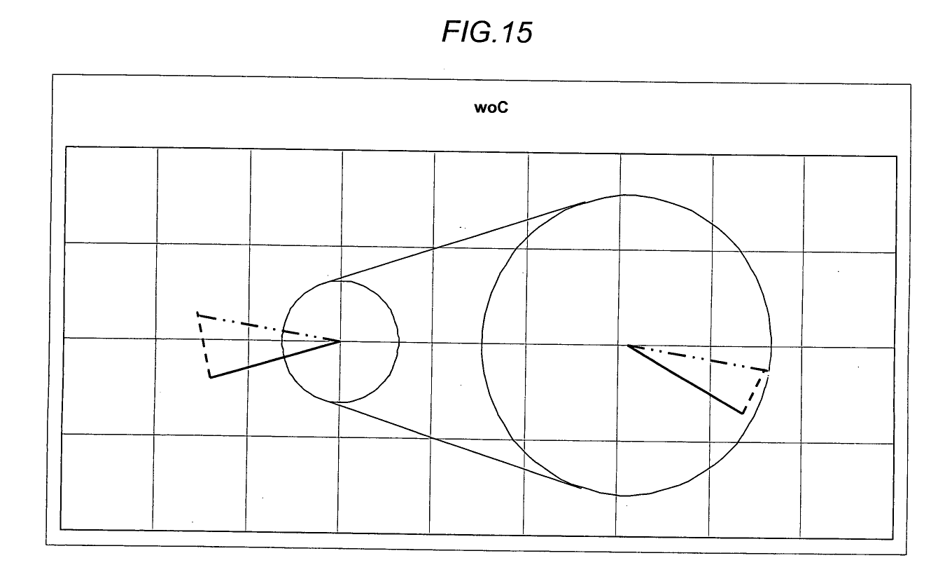

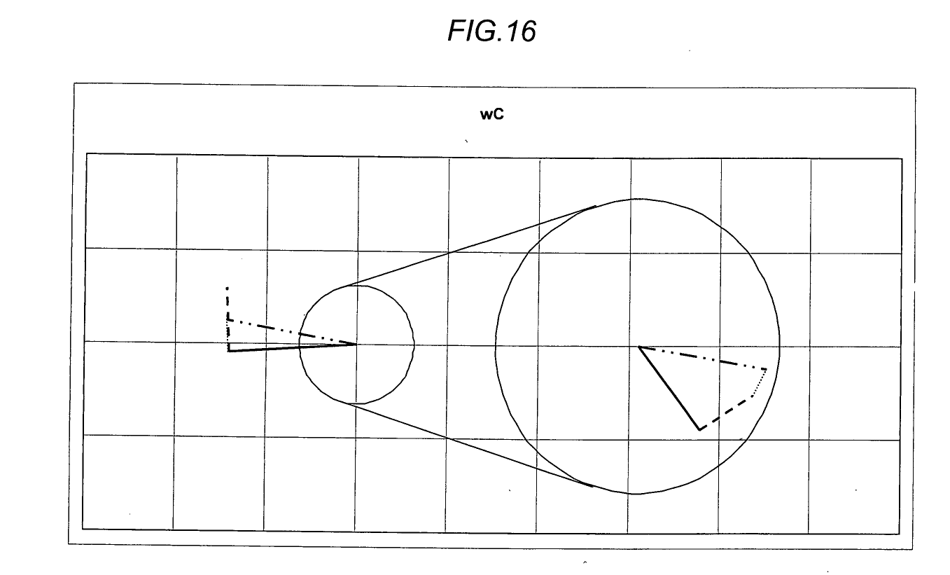

FIGS. 13 and 14 show resultant vectors for a low speed ratio (high gear ratio) simulation. FIGS. 15 and 16 show resultant vectors for a high speed ratio (low gear ratio) simulation. In FIGS. 13 to 16, the drive pulley is at left, and the driven pulley is at right.

In FIGS. 13 to 16, solid lines represent the resultant vectors for block-pulley normal force, dashed lines ( - - - ) represent the resultant vectors for circumferential friction, fine dot lines ( . . . ) represent the resultant vectors for radial friction, and two-dot-chain lines represent the summation of the other three components. This two-dot-chain lines each indicates the “separation force vector”.

FIGS. 13 and 15 show results from simulations where pulley conical stiffness is not included (i.e. pulley face is rigidly attached to pulley shaft). In these cases, the resultant vector from radial friction is almost non-existent. This is to be expected, because the rigid pulley does not allow block to “wedge in” or “wedge out” on the pulley face.

On the other hand, FIGS. 14 and 16 show results from simulations where pulley conical stiffness is included. In these cases, radial friction is significant, and influences the magnitude of the separation force vector, when compared to the rigid case.

As stated above, the embodiment is configured to have the computer simulator 40 for the CVT (continuously variable transmission) 10 having the metal-pushing belt (V-belt) 12 comprising at least a plurality of blocks 22 and a ring 24 mounted on the blocks and wound around pulleys 14, 16, comprising: the (system) multi-body simulation (MBS) unit 40b that performs multi-body simulation (MBS) using a multi-body simulation model (MBS model), comprising a block model 40b11, a ring model 40b12 and a pulley (face) model 40b21, which model components of a belt (V-belt) system comprising the blocks 22, the ring 22 and the pulleys 14, 16 and which describes a bending force acting on the ring based on a positional relationship of the blocks relative to the ring; the thrust controller 40b24 that controls pulley thrust of the pulley model such that a speed ratio to be transmitted converges to a desired speed ratio in the multi-body simulation; the (system) non-linear FE analysis unit 40c that inputs the pulley thrust when the controller is in operation and analyzes non-linear element of the belt system using a finite element (FE) model that models the non-linear element of the belt system through a finite element method (FEM), to predict stresses acting on the components of the belt system; and the durability (durability/lifetime) analysis unit 40d that inputs the predicted stresses and predicts durability of the components of the belt system.

In the computer simulator 40, the conical deflection of at least one of the pulleys 14, 16 is modeled in the pulley (face) model 40b21 in stiffness (pulley conical stiffness calculation unit 40b5), and the pulley conical stiffness is defined by a function of radius of the blocks on a face of the pulley.

The computer simulator 40 further includes: the visualization unit (resultant vector plot unit 40b34) that visualizes forces acting on the multi-body simulation model in vector form.

Provisional Patent Application No. 60/548,101, filed on Feb. 27, 2004, in the United States, is incorporated herein in its entirety.

While the present invention has thus been shown and described with reference to specific embodiments, it should be noted that the present invention is in no way limited to the details of the described arrangements; changes and modifications may be made without departing from the scope of the appended claims.

1. A computer simulator for a continuously variable transmission having a metal-pushing belt comprising at least a plurality of blocks and a ring mounted on the blocks and wound around pulleys, comprising:
a multi-body simulation unit that performs multi-body simulation using a multi-body simulation model, comprising a block model, a ring model and a pulley model, which model components of a belt system comprising the blocks, the ring and the pulleys and which describes a bending force acting on the ring based on a positional relationship of the blocks relative to the ring;
a thrust controller that controls pulley thrust of the pulley model such that a speed ratio to be transmitted converges to a desired speed ratio in the multi-body simulation;
a non-linear FE analysis unit that inputs the pulley thrust when the controller is in operation and analyzes non-linear element of the belt system using a finite element model that models the non-linear element of the belt system through a finite element method, to predict stresses acting on the components of the belt system; and
a durability analysis unit that inputs the predicted stresses and predicts durability of the components of the belt system.

2. The computer simulator according to claim 1, wherein conical deflection of at least one of the pulleys is modeled in the pulley model in stiffness.

3. The computer simulator according to claim 2, wherein the pulley conical stiffness is defined by a function of radius of the blocks on a face of the pulley.

4. The computer simulator according to claim 1, further including:
a visualization unit that visualizes forces acting on the multi-body simulation model in vector form.

5. A computer simulation method for a continuously variable transmission having a metal-pushing belt comprising at least a plurality of blocks and a ring mounted on the blocks and wound around pulleys, comprising the steps of:
performing multi-body simulation using a multi-body simulation model, comprising a block model, a ring model and a pulley model, which model components of a belt system comprising the blocks, the ring and the pulleys and which describes a bending force acting on the ring based on a positional relationship of the blocks relative to the ring;
controlling pulley thrust of the pulley model such that a speed ratio to be transmitted converges to a desired speed ratio in the multi-body simulation;
inputting the pulley thrust when the control is in operation and analyzing non-linear element of the belt system using a finite element model that models the non-linear element of the belt system through a finite element method, to predict stresses acting on the components of the belt system; and
inputting the predicted stresses and predicting durability of the components of the belt system.

6. The computer simulation method according to claim 5, wherein conical deflection of at least one of the pulleys is modeled in the pulley model in stiffness.

7. The computer simulation method according to claim 6, wherein the pulley conical stiffness is defined by a function of radius of the blocks on a face of the pulley.

8. The computer simulation method according to claim 5, further including the step of:
visualizing forces acting on the multi-body simulation model in vector form.
